(19) United States
(12) Patent Application Publication
(10) Pub. No.: US 2026/0240353 A1
(43) Pub. Date: Aug. 20, 2026

(54) SHOWER ROD DEVICE WITH INTEGRATED LIGHTING UNITS

(71) Applicant: Roy Kindred, Plano, TX (US)

(72) Inventor: Roy Kindred, Plano, TX (US)

(21) Appl. No.: 19/058,158

(22) Filed: Feb. 20, 2025

(51) Int. Cl. A47H 1/02; F21S 4/28; F21S 9/02; F21V 5/04; F21V 23/00; F21V 23/04; F21V 33/00; F21Y 103/10

(52) U.S. Cl. CPC A47H 1/02; F21S 4/28; F21S 9/02; F21V 5/043; F21V 23/006; F21V 23/0435; F21V 33/004; A47H 2001/0215; F21Y 2103/10

(57) ABSTRACT

A shower rod device with integrated lighting units is provided. Preferably, the device may be configured to support a curtain, such as a shower curtain, and to emit illumination in the environment proximate to the device. In some embodiments, the device may include an elongated body having a first end and a second end. An elongated channel may be formed in the elongated body. A light track may be coupled to the elongated body and positioned in the elongated channel, and the light track may have an elongated length. A plurality of lighting units may be coupled to the light track, and the plurality of lighting units may be dispersed along the elongated length of the light track. A lens cover may be positioned above the light track and the plurality of lighting units, and the lens cover may extend over each lighting unit of the plurality of lighting units.

### FIELD OF THE INVENTION

This patent specification relates to the field of devices for providing supplemental lighting to selected areas. More specifically, this patent specification relates to a curtain rod device that is configured to generate illumination and to support a curtain, such as a shower curtain.

### BACKGROUND

Many individuals desire to add to or to increase the amount of light in one or more areas of their temporary or permanent place of residence. For example, many individuals wish that their bathroom and shower area had one or more additional sources of light, such as for safety and/or aesthetic reasons. Unfortunately, it is often difficult and expensive to wire and install additional light sources. For this reason, many individuals postpone or forgo adding light sources in their temporary or permanent place of residence.

Therefore, a need exists for novel devices for providing supplemental lighting to selected areas. A further need exists for novel lighting devices which are less difficult and less expensive to install compared to existing options. There is also a need for novel devices which can provide illumination for a plurality of safety and/or aesthetic reasons.

### BRIEF SUMMARY OF THE INVENTION

A shower rod device with integrated lighting units is provided. Preferably, the device may be configured to support a curtain, such as a shower curtain, and to emit illumination in the environment proximate to the device. In some embodiments, the device may include an elongated body having a first end and a second end. An elongated channel may be formed in the elongated body. A light track may be coupled to the elongated body and positioned in the elongated channel, and the light track may have an elongated length. A plurality of lighting units may be coupled to the light track, and the plurality of lighting units may extend along the elongated length of the light track. A lens cover may be positioned above the light track and the plurality of lighting units, and the lens cover may extend over each lighting unit of the plurality of lighting units.

In further embodiments, the device may include a control unit that may be in electrical communication with the plurality of lighting units, and the control unit may be configured to control illumination generated by the plurality of lighting units.

In further embodiments, the device may include a wireless interface that may be in electronic communication with the control unit. The control unit may be configured to control illumination generated by the plurality of lighting units in response to the wireless interface receiving a wireless signal, such as which may be generated by a computing device, such as a smartphone.

In further embodiments, the device may include a remote control that is operable to generate a wireless signal, and the control unit may modulate illumination generated by the plurality of lighting units in response to the wireless interface receiving the wireless signal.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an elevation view of an example of a shower rod device with integrated lighting units supporting an example curtain according to various embodiments described herein.

FIG. 2 illustrates a perspective view of an example of a shower rod device having an elongated body made of a transparent material so that some components that may be disposed within the elongated body may be visualized for purposes of description according to various embodiments described herein.

FIG. 3 shows a perspective exploded view of some example components of a shower rod device with integrated lighting units according to various embodiments described herein.

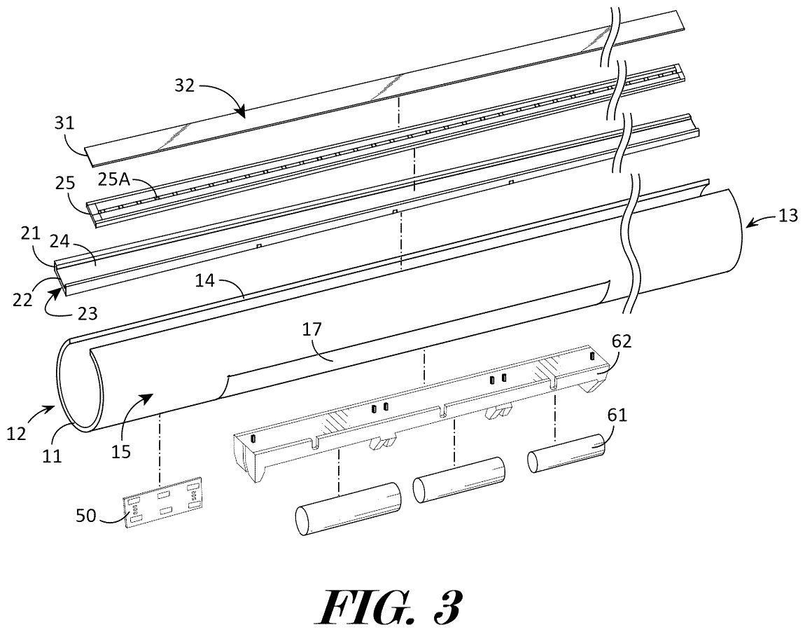

FIG. 4 depicts a sectional, through line 4-4 shown in FIG. 1, elevation view of an example of a shower rod device with integrated lighting units according to various embodiments described herein.

FIG. 5 illustrates a diagram view of an example of a shower rod device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

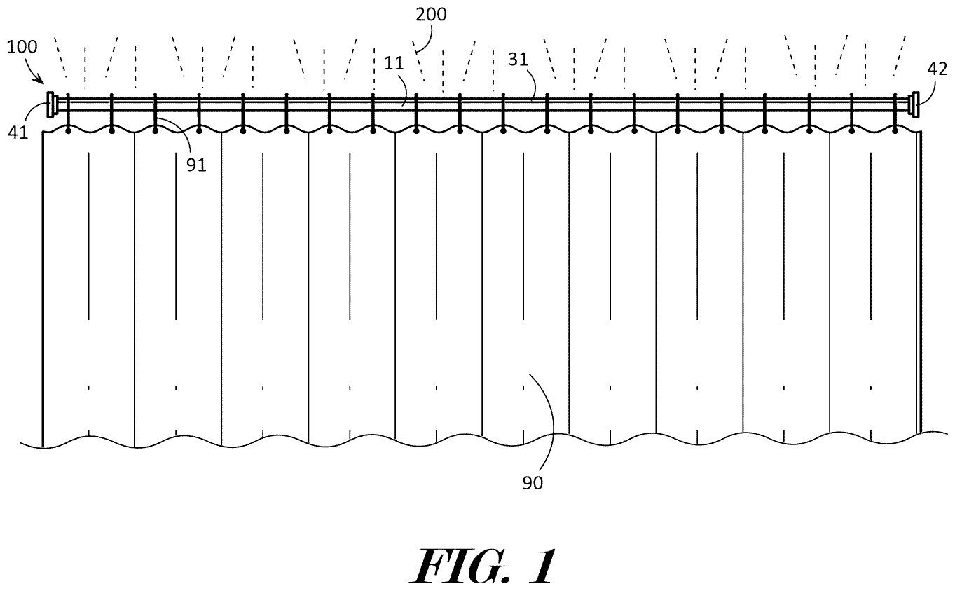

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

A new shower rod device with integrated lighting units is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments. FIGS. 1, 2, and 5 illustrate examples of a shower rod device with integrated lighting units (“the device”) 100 according to various embodiments. In some embodiments, the device 100 may comprise an elongated body 11 having a first end 12 and a second end 13. An elongated channel 14 may be formed in the elongated body 11. A light track 21 may be coupled to the elongated body and positioned in the elongated channel 14. The light track 21 may have an elongated length, and a plurality of lighting units 25 may be coupled to the light track 21. The plurality of lighting units 25 may extend along the elongated length of the light track 21. A lens cover 31 may be positioned above the light track 21 and the plurality of lighting units 25, and the lens cover 31 may extend over each lighting unit 25A of the plurality of lighting units 25.

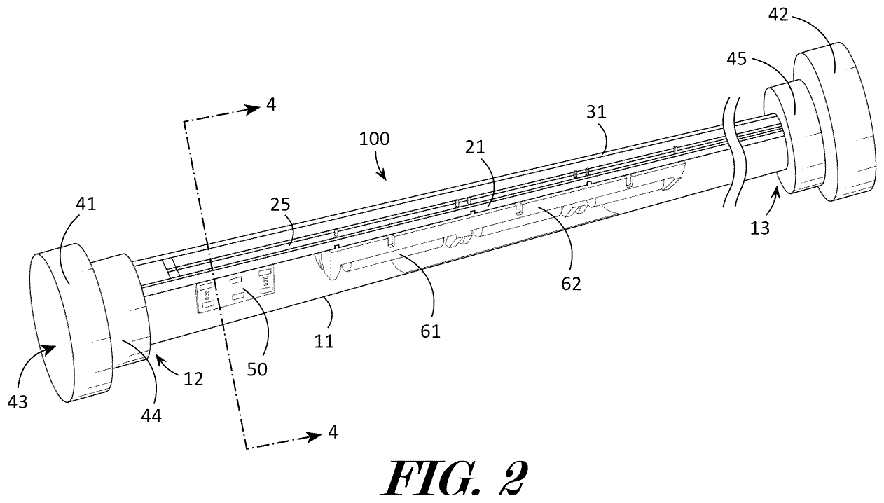

The device 100 may comprise an elongated body 11 having a first end 12 and an opposing second end 13. The elongated body 11 may be elongated so as to have a length (distance between the first end 12 and second end 13) that is significantly greater in dimension than the height and width dimensions. An elongated body 11 may be configured in any elongated shape and size. FIG. 2 illustrates an elongated body 11 made of a transparent material so that some components that may be disposed within the elongated body may be visualized for patent description purposes, however, the elongated body 11 may be made from opaque materials, transparent materials, translucent materials, or a combination of these materials. Preferably, an elongated body 11 may be made from or may comprise a substantially rigid material, such as aluminum or other metal, high-density polyethylene (HDPE), polyvinyl chloride (PVC), polypropylene (PP), other substantially rigid plastics, etc., that may be suitable for structurally supporting a curtain 90, such as a shower curtain, and its hanging hardware 91, such as curtain rings, hooks, etc., so that all or portions of the elongated body 11 may function as a curtain rod. The elongated body 11 preferably may comprise a major exterior surface 15 that may form the surface of the elongated body 11 that is outside of the elongated channel 14. Generally, hanging hardware 91 may contact and move across the major exterior surface 15.

In some embodiments, the elongated body 11 may comprise a body cavity 16 which may be formed into the elongated body 11 below the major exterior surface 15. A body cavity 16 may be configured in any shape and size. Preferably, a body cavity 16 may be shaped to receive a control unit 50, a wireless interface 51, and/or the one or more power sources 61 so that the control unit 50, wireless interface 51, and/or the one or more power sources 61 may be enclosed in the elongated body 11 (positioned below the major exterior surface 15 of the elongated body 11). Optionally, the one or more power sources 61 may be accessed or removed from the elongated body 11 via an access or battery door 17 that may be formed in or otherwise coupled to the elongated body 11, by removing an end cap 42, or by any other commonly used method of accessing a power source 61 that is enclosed within a body of a device.

An elongated body 11 may comprise an elongated channel 14 that may be formed in the elongated body 11. An elongated channel 14 may be configured in any shape and size. An elongated channel 14 may comprise a depression or recess in the elongated body 11 that may be recessed below the major exterior surface 15 of the elongated body 11. In some embodiments, an elongated channel 14 may extend substantially between the first end 12 and the second end 13 of the elongated body 11 (at least 95% of the distance between the first end 12 and the second end 13). In further embodiments, an elongated channel 14 may extend at least approximately 25% of the distance between the first end 12 and the second end 13. Preferably, an elongated channel 14 may be formed into the elongated body 11 having a depth that is sufficient to receive the light track 21, plurality of lighting units 25, and at least a portion of the lens cover 31 so that the cover exterior surface 32 of the lens cover 31 may be substantially flush with the major exterior surface 15 of the elongated body 11 when the light track 21, plurality of lighting units 25, lens cover 31, and the elongated body 11 are coupled together.

The device 100 may comprise a plurality of lighting units 25 that may include any number of individual lighting units 25A. The individual lighting units 25A may be dispersed, preferably evenly dispersed or spaced apart, along the elongated length of the light track 21. The individual lighting units 25A may be coupled together to form an elongated plurality of lighting units 25. The individual lighting units 25A of the plurality of lighting units 25 may be configured to illuminate with various colors and intensities of light 200 allowing a plurality of color patterns and intensity patterns of light 200 to be generated by the device 100. In some embodiments, individual lighting units 25A may comprise a light emitting diode (LED) which may be configured to provide light 200 of various wavelengths and intensities. In other embodiments, individual lighting units 25A may comprise an organic light-emitting diode (OLED), incandescent light bulb, fluorescent light bulb, halogen light bulb, high-intensity discharge light bulb, laser light emitter, electroluminescent light source, neon light source, or any other type of suitable light source.

The device 100 may comprise a light track 21 to which the plurality of lighting units 25 may be coupled to. Generally, a light track 21 may comprise an elongated length of material which may structurally support the plurality of lighting units 25 and couple the plurality of lighting units 25 to the elongated body 11 within an elongated channel 14. Preferably, a light track 21 may comprise plastic or other structural materials. Optionally, a light track 21 may comprise a single unit or two or more subunits which may be coupled together. A light track 21 may be configured in any size and shape. Preferably, a light track 21 may comprise an elongated shape. Preferably, the device 100 may comprise a light track 21 that may be coupled to the elongated body 11 within the elongated channel 14, and the elongated length of the light track 21 may extend substantially (greater than 95%) of the length of the elongated channel 14.

In preferred embodiments, a light track 21 may comprise a base wall 22, and the base wall 22 may comprise a base surface 23 and a recessed portion 24 that may be positioned on opposite sides of the base wall 22. The base surface 23 may be coupled to the elongated body 11, and the plurality of lighting units 25 may be coupled to the recessed portion 24 of the light track 21.

The device 100 may comprise a lens cover 31 that may be positioned above the light track 21 and the plurality of lighting units 25 when the light track 21 and the plurality of lighting units 25 are coupled to the elongated body 11 within the elongated channel 14. A lens cover 31 may be configured in any size and shape. Preferably, a lens cover 31 may be elongated in shape so that when the lens cover 31 is coupled to the elongated body 11, the lens cover 31 may extend over each lighting unit 25A of the plurality of lighting units 25. Preferably, a lens cover 31 may be elongated in shape and when coupled to the elongated body 14, the lens cover 31 may extend substantially (greater than 95% of the distance) between the first end 12 and the second end 13.

In some embodiments, a lens cover 31 may be coupled directly to the elongated body 11 by being coupled to portions of the elongated body 11 that are proximate to and/or positioned within the elongated channel 14. In some embodiments, a lens cover 31 may be coupled indirectly to the elongated body 11 by being coupled to the light track 21 and/or to the plurality of lighting units 25 when the light track 21 and the plurality of lighting units 25 are coupled to the elongated body 11 within the elongated channel 14.

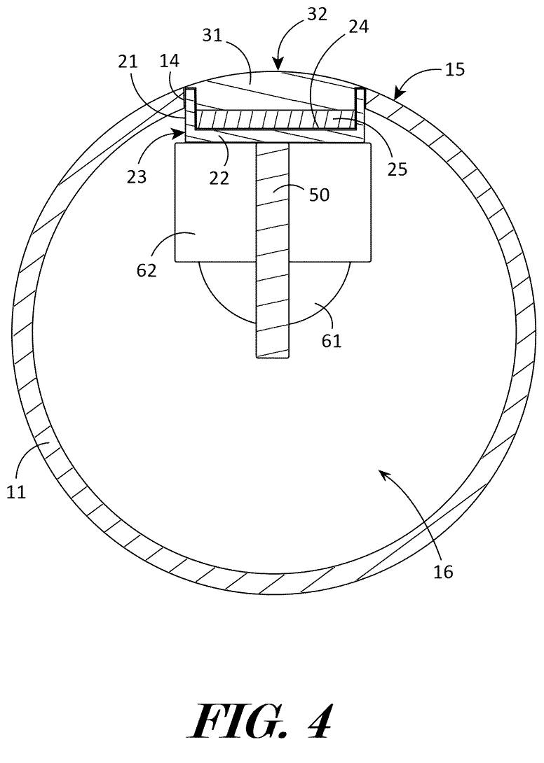

In preferred embodiments, a lens cover 31 and the elongated body 14 may be coupled together to form an elongated cylindrical shape, similar to an elongated cylindrical curtain rod. For example, and as perhaps best shown in FIG. 4, a cover exterior surface 32 and a major exterior surface 15 may each comprise an arc shape in cross section so that when the lens cover 31 and elongated body 11 are coupled together, they may form a generally oval or circular shape in cross section. In further embodiments, a cover exterior surface 32 and a major exterior surface 15 may comprise any other shape so that when a lens cover 31 and the elongated body 14 are coupled together they may form an elongated rectangular prism shape, elongated triangular prism shape, elongated pentagonal shape, or any other shape including combinations of shapes.

A lens cover 31 may be transparent or translucent by being made from or by comprising a substantially transparent or translucent material so that light from the plurality of lighting units 25 may exit the elongated channel 14 through the lens cover 31. Preferably, a lens cover 31 may be made from or may comprise one or more durable and rigid materials which may be substantially transparent or translucent. Example durable and rigid materials which may be substantially transparent or translucent include plastics such as polycarbonate, acrylic or polyacrylate made from Methyl Methacrylate (MMA), Poly Methyl Methacrylate, or a combination of both, polystyrene, and glass.

In preferred embodiments, the device 100 may comprise one or more end caps 41, 42, such as a first end cap 41 and a second end cap 42. For example, the device 100 may comprise a first end cap 41 that may be coupled to the first end 12 of the elongated body 11 and a second end cap 42 that may be coupled to the second end 13 of the elongated body 11. Each end cap 41, 42, may comprise a cap surface 43 which may be configured to contact and press against an object, e.g., a shower wall, in order to engage the device 100 to one or more objects. A cap surface 43 may be configured in any shape and size, preferably by being generally flat or planar in shape.

In preferred embodiments, an end cap 41, 42, and/or its cap surface 43 may be made from and/or may comprise a resilient material which when placed into contact with another material may contribute to a relatively high friction of coefficient between the resilient material and the other material. Preferably, a resilient material may be a natural and/or synthetic material, which is flexible to allow slight deformation and resilient so as to return to its original shape after deformation. Example resilient materials include latex rubber, silicone rubber, forms of the organic compound isoprene, such as polyisoprene, Butyl rubber, Polyacrylate Rubber, Ethylene-acrylate Rubber, Polyester Urethane, etc.

In preferred embodiments, one or more end caps 41, 42, may be rotatably coupled to the elongated body 11. For example, the device 100 may comprise a first end cap 41 and/or a second end cap 42 that may be rotatably coupled to the elongated body 11 so that the first end cap 41 and/or second end cap 42 is able to rotate relative to the elongated body 11 (rotate around an axis that may extend through the first end 12 and the second end 13). Preferably, an end cap 41, 42, may be rotatably coupled to the elongated body 11 via a rotatable coupling 44, 45. Optionally, a rotatable coupling 44, 45, may be configured to function as a rotatable tensioning device to control the distance between the end caps 41, 42, such as which may be used to engage the device 100 between to walls or objects. A rotatable coupling 44, 45, may comprise a ball joint, pivot pin, bearing, or other movable coupling that may enable an end cap 41, 42, to be able to rotate relative to the elongated body 11. Preferably, by having one or more end caps 41, 42, that may be rotatably coupled to the elongated body 11, the elongated body 11 may be rotated relative to the walls or other objects that the device 100 is engaged to in order to allow a user to orient the lens cover 31, and therefore orient the direction of the light 200 emitted by the device 100, in a desired direction.

The device 100 may comprise one or more power sources 61 which may be configured to provide electric power that may be used by the plurality of lighting units 25 to generate illumination (light 200). In preferred embodiments, a power source 61 may comprise a rechargeable power source, such as a rechargeable lithium-ion battery, rechargeable nickel cadmium battery, etc. In some embodiments, a power source 61 may comprise a battery, such as a lithium-ion battery, nickel cadmium battery, alkaline battery, or any other suitable type of battery, a fuel cell, a capacitor, a super capacitor, or any other type of electricity storing and/or releasing device. In further embodiments, a power source 61 may comprise a power cord, kinetic or piezo electric battery charging device, a solar cell or photovoltaic cell, and/or inductive charging or wireless power receiver. In further embodiments, a power source 61 may comprise a power charging and distribution module which may be configured to control the recharging of the power source 61, discharging of the power source 61, and/or distribution of power to one or more components of the device 100 that may require electrical power. Optionally, the device 100 may comprise a power source holder 62 which may comprise a structure for removably coupling two or more power sources 61 together, such as in series or in parallel.

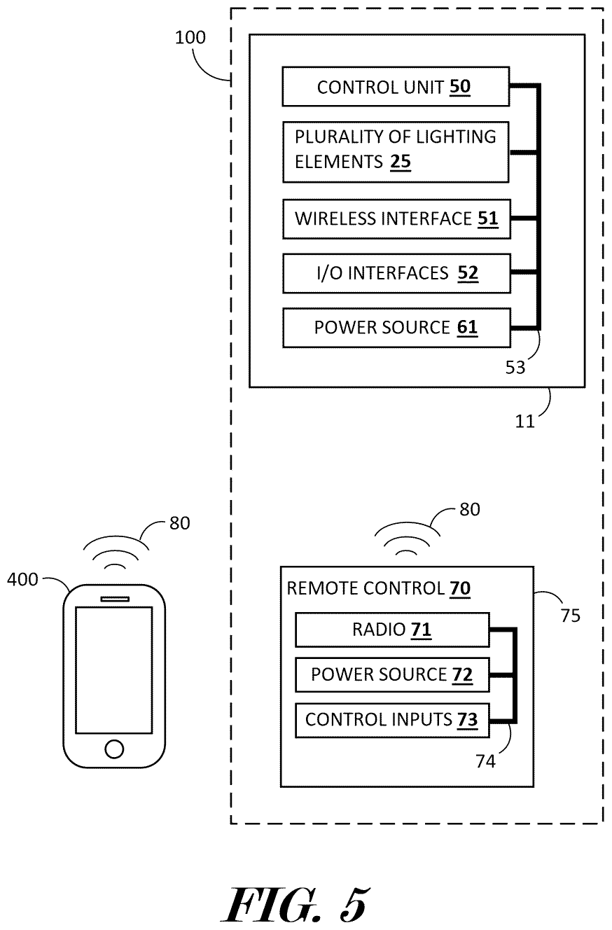

In some embodiments, the device 100 may comprise a control unit 50 which may be in electronic communication with the plurality of lighting units 25 and a power source 61, and the control unit 50 may be configured to control the illumination generated by the plurality of lighting units 25. For example, a control unit 50 may be configured to control the illumination generated by the plurality of lighting units 25, by turning on the illumination, by turning off the illumination, by increasing or decreasing the illumination, by changing the color of the illumination, etc. As another example, a control unit 50 may be configured to modulate or change the illumination generated by the plurality of lighting units 25, by turning on the illumination of one or more lighting units 25A, by turning off the illumination of one or more lighting units 25A, by increasing or decreasing the illumination generated by one or more lighting units 25A, by changing the color of the illumination generated by one or more lighting units 25A, etc. It should be appreciated by those of ordinary skill in the art that FIG. 5 depicts the device 100 in an oversimplified manner, and a practical embodiment may include additional components or elements and suitably configured processing logic to support known or conventional operating features that are not described in detail herein.

A control unit 50 may be a hardware device for executing software instructions. The control unit 50 may comprise any custom made or commercially available processor, a central processing unit (CPU), a semiconductor-based microprocessor (in the form of a microchip or chip set), or generally any device for executing software instructions or performing logic based operations. When the control unit 50 is in operation, the control unit 50 is configured to control the illumination generated by the plurality of lighting units 25 pursuant to software instructions, input/output interfaces 52, and/or from instructions received from a wireless interface 51. In an exemplary embodiment, the control unit 50 may comprise a processor that may be a mobile optimized processor, such as optimized for power consumption and mobile applications.

In preferred embodiments, the device 100 may comprise a wireless interface 51 that may be in electronic communication with the control unit 50. A wireless interface 51 enables wireless communication to an external access device or network. In preferred embodiments, a wireless interface 51 may operate via Bluetooth and/or WiFi communication standards so that the wireless interface 51 may receive Bluetooth and/or WiFi wireless signals 80. Any number of suitable wireless data communication protocols and wireless signals 80, techniques, or methodologies can be supported by the wireless interface 51, including, without limitation: RF; IrDA (infrared); Bluetooth; ZigBee (and other variants of the IEEE 802.15 protocol); IEEE 802.11 (any variation); IEEE 802.16 (WiMAX or any other variation); etc.

Input/output (I/O) interfaces 52 can be used by a user to provide user input and display device output data, such as operational status, from the device 100. The I/O interfaces 52 can include, for example, buttons, knobs, switches, LED indicator lights, LED display, LCD display, a serial port, a parallel port, a small computer system interface (SCSI), an infrared (IR) interface, a radio frequency (RF) interface, a universal serial bus (USB) interface, and the like. In some embodiments, I/O interfaces 52 may comprise buttons, knobs, switches, etc., that may be manipulated by a user to enable the user to select one or more illumination settings for control unit 50 to control or modulate the illumination generated by the plurality of lighting units 25.

The control unit 50, plurality of lighting units 25, power source(s) 61, wireless interface 51, input/output interfaces 52 and one or more other elements may be communicatively coupled via a local interface 53. The local interface 53 can be, for example but not limited to, one or more buses, circuit boards, wiring harnesses, or other wired connections or wireless connections, as is known in the art.

In some embodiments, a wireless interface 51 may be in electronic communication with a smartphone, tablet computer, or other computing device 400 via Bluetooth and/or WiFi communication so that the wireless interface 51 may receive a wireless signal 80 having illumination instructions from the computing device, and the illumination instructions may be communicated to the control unit 50 and used by the control unit 50 to control or modulate illumination generated by the plurality of lighting units 25 in response to the wireless interface 51 receiving the wireless signal 80.

In some embodiments, a wireless interface 51 may be in electronic communication with a smartphone, tablet computer, or other computing device via Bluetooth and/or WiFi communication so that the wireless interface 51 may receive a wireless signal 80 having illumination instructions from the computing device, and the illumination instructions may be communicated to the control unit 50 and used by the control unit 50 to control or modulate illumination generated by the plurality of lighting units 25 in response to the wireless interface 51 receiving the wireless signal 80.

In some embodiments, the device 100 may comprise a remote control 70 which may be operable to generate a wireless signal 80, and the control unit 50 may control or modulate illumination generated by the plurality of lighting units 25 in response to the wireless interface 51 receiving the wireless signal 80. In electronics, a remote control 70 is an electronic device used to operate another device from a distance, usually wirelessly. Preferably, a remote control 70 may comprise a radio 71, a power source 72, and one or more control inputs 73 that may be in communication via local interface 74. Components 71, 72, 73, 74, may be contained in a small, handheld housing 75 commonly used by remote control devices that may be made from plastic, metal, or any other structural material. A control input 73 may comprise a button, knob, slider, touch screen, or other user input that may be operated by a user. A power source 72 may comprise a battery or other power source that may supply electricity to the radio 71 and one or more control inputs 73. In response to a control input 73 being operated by a user, the radio 71 may generate a wireless signal 80, and the control unit 50 may control or modulate illumination generated by the plurality of lighting units 25 in response to the wireless interface 51 receiving the wireless signal 80. Preferably, the radio 71 may generate a wireless signal 80 so that the housing 75 may be physically separated from the elongated body 11, such as two to twenty feet (or any other transmission distance common to handheld remote control devices) while enabling the wireless interface 51 to receive the wireless signal 80.

While some exemplary shapes and sizes have been provided for elements of the device 100, it should be understood to one of ordinary skill in the art that the elongated body 11, light track 21, plurality of lighting units 25, lens cover 31, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A shower rod device with integrated lighting units, the device comprising:
an elongated body having a first end and a second end;
an elongated channel formed in the elongated body;
a light track coupled to the elongated body and positioned in the elongated channel, the light track having an elongated length;
a plurality of lighting units coupled to the light track, wherein plurality of lighting units extends along the elongated length of the light track; and
a lens cover positioned above the light track and the plurality of lighting units, wherein the lens cover extends over each lighting unit of the plurality of lighting units.

2. The device of claim 1, wherein the lens cover and the elongated body are coupled together to form an elongated cylindrical shape.

3. The device of claim 1, further comprising a first end cap coupled to the first end of the elongated body, and further comprising a second end cap coupled to the second end of the elongated body.

4. The device of claim 3, wherein the first end cap is rotatably coupled to the elongated body so that the first end cap is able to rotate relative to the elongated body.

5. The device of claim 1, wherein the elongated channel extends substantially between the first end and the second end.

6. The device of claim 1, further comprising a power source, wherein the power source is enclosed in the elongated body.

7. The device of claim 1, wherein the light track comprises a recessed portion, and wherein the plurality of lighting units is coupled to the recessed portion of the light track.

8. The device of claim 1, wherein the lens cover is one of transparent and translucent.

9. The device of claim 1, wherein the lens cover is coupled to the elongated body and extends substantially between the first end and the second end.

10. A shower rod device with integrated lighting units, the device comprising:
an elongated body having a first end and a second end;
an elongated channel formed in the elongated body;
a light track coupled to the elongated body and positioned in the elongated channel, the light track having an elongated length;
a plurality of lighting units coupled to the light track, wherein plurality of lighting units extends along the elongated length of the light track;
a lens cover positioned above the light track and the plurality of lighting units, wherein the lens cover extends over each lighting unit of the plurality of lighting units; and
a control unit in electrical communication with the plurality of lighting units, the control unit is configured to control illumination generated by the plurality of lighting units.

11. The device of claim 10, further comprising a wireless interface, wherein the wireless interface is in electronic communication with the control unit, and wherein the control unit modulates illumination generated by the plurality of lighting units in response to the wireless interface receiving a wireless signal.

12. The device of claim 11, further comprising a remote control, wherein the remote control is operable to generate the wireless signal, and wherein the control unit modulates illumination generated by the plurality of lighting units in response to the wireless interface receiving the wireless signal.

13. The device of claim 10, wherein the lens cover and the elongated body are coupled together to form an elongated cylindrical shape.

14. The device of claim 10, further comprising a first end cap coupled to the first end of the elongated body, and further comprising a second end cap coupled to the second end of the elongated body.

15. The device of claim 14, wherein the first end cap is rotatably coupled to the elongated body so that the first end cap is able to rotate relative to the elongated body.

16. The device of claim 10, wherein the elongated channel extends substantially between the first end and the second end.

17. The device of claim 10, further comprising a power source, wherein the power source is enclosed in the elongated body.

18. The device of claim 10, wherein the light track comprises a recessed portion, and wherein the plurality of lighting units is coupled to the recessed portion of the light track.

19. The device of claim 10, wherein the lens cover is one of transparent and translucent.

20. The device of claim 10, wherein the lens cover is coupled to the elongated body and extends substantially between the first end and the second end.
